(19) United States
(12) Patent Application Publication
(10) Pub. No.: US 2025/0293551 A1
(43) Pub. Date: Sep. 18, 2025

(54) WIRELESS POWER RECEIVING DEVICE AND METHOD OF OPERATING THE SAME

(71) Applicant: Samsung Electronics Co., Ltd., Suwon-si (KR)

(72) Inventors: Dohyung KIM, Suwon-si (KR); Solhee IN, Suwon-si (KR); Sun Ki HONG, Suwon-si (KR); Hongsoo PARK, Seoul (KR); Youngjin SONG, Seoul (KR); Byungwook JUNG, Suwon-si (KR)

(73) Assignee: Samsung Electronics Co., Ltd., Suwon-si (KR)

(21) Appl. No.: 18/965,155

(22) Filed: Dec. 2, 2024

(30) Foreign Application Priority Data
Mar. 12, 2024 (KR) 10-2024-0034276

(51) Int. Cl. H02J 50/27; G06F 1/26; H01M 10/0525; H01M 10/44; H01M 10/46; H01Q 1/24; H02J 50/40; H02J 50/90

(52) U.S. Cl. CPC H02J 50/27; G06F 1/26; H01M 10/0525; H01M 10/44; H01M 10/46; H01Q 1/248; H02J 50/402; H02J 50/90

(57) ABSTRACT

A wireless power receiving device includes rectennas configured to generate sub-direct current (DC) powers based on sub-alternating current (AC) powers, a DC power combining circuit, processing circuitry configured to divide the rectennas into first to third groups based on power distribution information and first and second reference values, the power distribution information being based on the sub-AC powers, generate a control signal based on the first to third groups including different numbers of rectennas, control the DC power combining circuit to perform a series connection and a parallel connection for the plurality of sub-DC powers based on the control signal, the DC power combining circuit being configured to generate a combined DC power by performing a power synthesis based on the series connection and the parallel connection, and generate an output power based on the combined DC power, and a battery configured to store the output power.

### CROSS-REFERENCE TO RELATED APPLICATION

This application claims priority under 35 USC § 119 to Korean Patent Application No. 10-2024-0034276 filed on Mar. 12, 2024 in the Korean Intellectual Property Office (KIPO), the contents of which are herein incorporated by reference in their entirety.

### BACKGROUND

### 1. Technical Field

Example embodiments relate generally to wireless power transmission and reception, and more particularly to wireless power receiving devices and methods of operating the wireless power receiving devices.

### 2. Description of the Related Art

Rectenna is an abbreviation for Rectifying Antenna, and has a structure that combines a rectifier circuit and an antenna. In the rectenna, the antenna may receive electromagnetic waves (e.g., microwave power) transmitted wirelessly through the air, and the rectifier circuit including diodes and filters may convert the electromagnetic waves into direct current (DC) signals. Such rectennas may be employed to transmit and/or receive power. For example, a target power may be received by arranging a plurality of rectennas. Recently, as systems for transmitting and receiving efficient radio frequency (RF) power have been developed, methods for receiving RF power by a plurality of rectennas are being studied.

### SUMMARY

Example embodiments of the present disclosure provides a wireless power receiving device capable of efficiently obtaining a target power.

Example embodiments of the present disclosure provides a method of operating the wireless power receiving device.

According to example embodiments, a wireless power receiving device includes a plurality of rectennas configured to generate a plurality of sub-direct current (DC) powers based on a plurality of sub-alternating current (AC) powers received from an external source, a DC power combining circuit, processing circuitry configured to divide the plurality of rectennas into one or more first groups, a plurality of second groups and a plurality of third groups based on power distribution information, a first reference value and a second reference value, the power distribution information being based on the plurality of sub-AC powers, generate a control signal based on the one or more first groups, the plurality of second groups and the plurality of third groups including different numbers of rectennas, control the DC power combining circuit to perform a series connection and a parallel connection for the plurality of sub-DC powers based on the control signal, the DC power combining circuit being configured to generate a combined DC power by performing a power synthesis based on the series connection and the parallel connection, and generate an output power based on the combined DC power, and a battery configured to store the output power.

According to example embodiments, in a method of operating a wireless power receiving device including a plurality of rectennas, processing circuitry, a direct current (DC) power combining circuit and a battery, the method including generating, by the plurality of rectennas, a plurality of sub-DC powers based on a plurality of sub-alternating current (AC) powers, dividing, by the processing circuitry, the plurality of rectennas into a one or more first groups, a plurality of second groups and a plurality of third groups based on power distribution information, a first reference value and a second reference value, the power distribution information being based on the plurality of sub-AC powers, generating, by the processing circuitry, a control signal based on the one or more first groups, the plurality of second groups and the plurality of third groups including different numbers of rectennas, controlling, by the processing circuitry, a DC power combining circuit to generate a combined DC power by performing a series connection and a parallel connection for the plurality of sub-DC powers based on the control signal, generating, by the processing circuitry, an output power based on the combined DC power, and storing the output power in the battery.

According to example embodiments, a wireless power receiving device includes a plurality of rectennas configured to generate a plurality of sub-direct current (DC) powers based on a plurality of sub-alternating current (AC) powers, a DC power combining circuit, processing circuitry configured to divide the plurality of rectennas into a one or more first groups, a plurality of second groups and a plurality of third groups based on power distribution information, a first reference value and a second reference value, the power distribution information being based on the plurality of sub-AC powers, generate a control signal based on the one or more first groups, the plurality of second groups, and the plurality of third groups, control the DC power combining circuit to perform a series connection and a parallel connection for the plurality of sub-DC powers based on the control signal, the DC power combining circuit being configured to generate a combined DC power by performing a power synthesis based on the series connection and the parallel connection, and generate an output power based on the combined DC power, and a battery configured to store the output power, wherein a number of rectennas included in each of the one or more first groups is one, a number of rectennas included in each of the plurality of second groups is N, N being an integer greater than or equal to two, a number of rectennas included in each of the plurality of third groups is M, M being an integer greater than or equal to three, and M being greater than N, the processing circuitry is configured to obtain the power distribution information from the plurality of sub-AC powers, set one rectenna having a magnitude of received sub-AC power greater than the first reference value as one of the one or more first groups based on the power distribution information, set N rectennas each having a magnitude of received sub-AC power greater than the second reference value and less than or equal to the first reference value as one of the plurality of second groups, set M rectennas each having a magnitude of received sub-AC power less than or equal to the second reference value as one of the plurality of third groups, generate grouping information related to the one or more first groups, the plurality of second groups and the plurality of third groups, and generate the control signal based on the grouping information, and the DC power combining circuit is configured to generate one of one or more first intermediate DC powers from the one rectenna included in one of the one or more first groups, generate one of a plurality of second intermediate DC powers by connecting N sub-DC powers in series, the N sub-DC powers being generated by the N rectenna included in one of the plurality of second groups, generate one of a plurality of third intermediate DC powers by connecting M sub-DC powers in series, the M sub-DC powers being generated by the M rectennas included in one of the plurality of third groups, and output the combined DC power by connecting the one or more first intermediate DC powers, the plurality of second intermediate DC powers and the plurality of third intermediate DC powers in parallel.

In wireless power receiving devices according to example embodiments, the power distribution diagram may be obtained based on the plurality of sub-AC powers received by the plurality of rectennas. The series connection and the parallel connection for the plurality of sub-DC powers output from the plurality of rectennas may be controlled using the obtained power distribution chart, and thus the target power may be efficiently obtained. In example embodiments, the output power may be divided into multiple powers to charge multiple batteries simultaneously (or contemporaneously).

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a wireless power receiving device according to example embodiments.

FIG. 2 is a block diagram illustrating a connection setup circuit included in a wireless power receiving device according to example embodiments.

FIGS. 3, 4 and 5 are diagrams for describing an operation of dividing a plurality of rectennas.

FIGS. 6, 7 and 8 are diagrams for describing a series and a parallel connection of a plurality of sub-direct current (DC) powers.

FIG. 9 is a circuit diagram illustrating an example of a plurality of rectennas included in a wireless power receiving device according to example embodiments.

FIGS. 10 and 11 are diagrams illustrating examples of wireless power receiving devices according to example embodiments.

FIGS. 12 and 13 are block diagrams illustrating examples of wireless power receiving devices according to example embodiments.

FIG. 14 is a diagram illustrating an example of an operation of dividing a plurality of rectennas.

FIG. 15 is a diagram illustrating a wireless power transmission and reception system including a wireless power receiving device according to example embodiments.

FIG. 16 is a flowchart illustrating a method of operating a wireless power receiving device according to example embodiments.

FIG. 17 is a block diagram illustrating an electronic device according to example embodiments in a network environment.

FIG. 18 is a block diagram illustrating an example of a program included in an electronic device of FIG. 17.

FIG. 19 is a block diagram illustrating an example of a wireless communication module, a power management module, and an antenna module included in an electronic device of FIG. 17.

### DETAILED DESCRIPTION

Various example embodiments will be described more fully with reference to the accompanying drawings, in which examples are shown. The present disclosure may, however, be embodied in many different forms and should not be construed as limited to the examples set forth herein. Like reference numerals refer to like elements throughout this application.

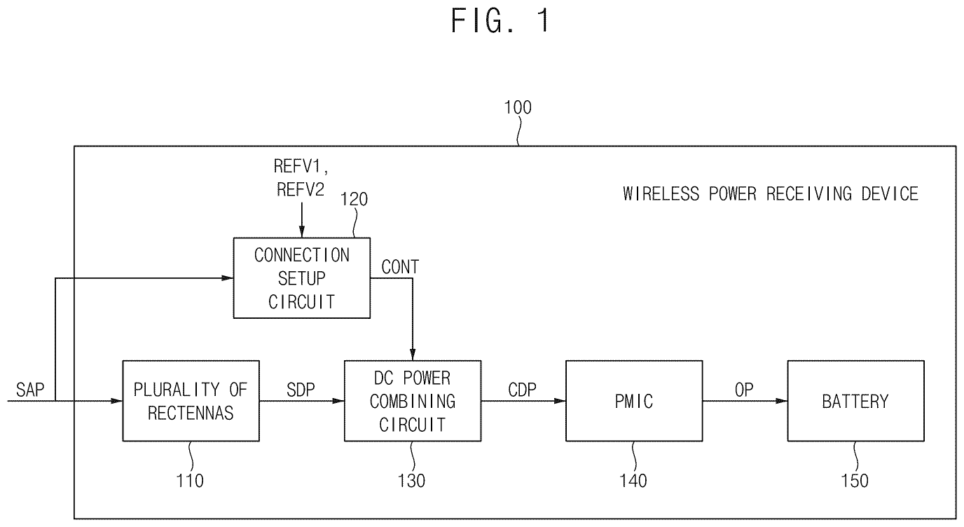

FIG. 1 is a block diagram illustrating a wireless power receiving device according to example embodiments.

Referring to FIG. 1, a wireless power receiving device 100 includes a plurality of rectennas 110, a connection setup circuit 120, a direct current (DC) power combining circuit 130, a power management integrated circuit (PMIC) 140, and/or a battery 150.

The plurality of rectennas 110 receive a plurality of sub-alternating current (AC) powers SAP. For example, a rectenna may represent a circuit or a device that combines an antenna and a rectifier circuit. For example, a plurality of sub-AC powers SAP may be referred to as radio frequency (RF) power. For example, a plurality of sub-AC powers SAP may represent a form of power for efficiently transmitting and receiving energy in a wireless power transmission and reception environment.

The plurality of rectennas 110 generate a plurality of sub-DC powers SDP based on the plurality of sub-AC powers SAP. For example, the plurality of rectennas 110 may convert AC power into DC power. For example, one of the plurality of rectennas may generate one of the plurality of sub-DC powers SDP based on one of the plurality of sub-AC powers SAP.

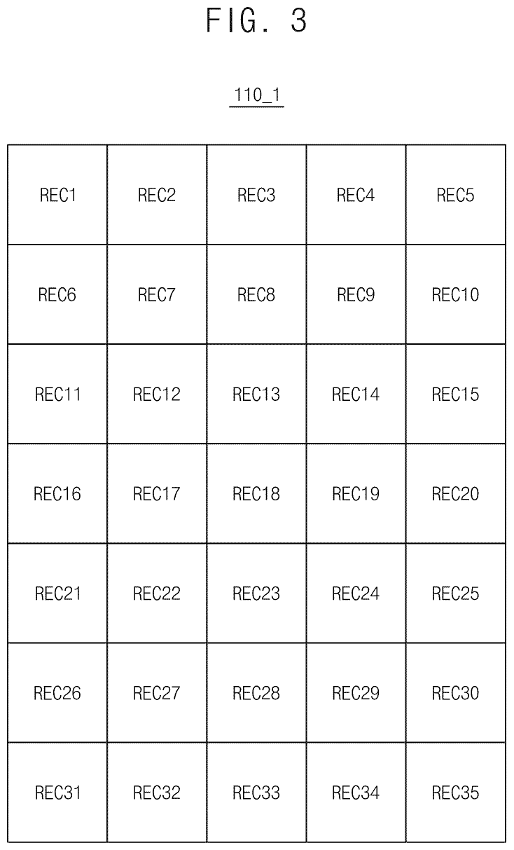

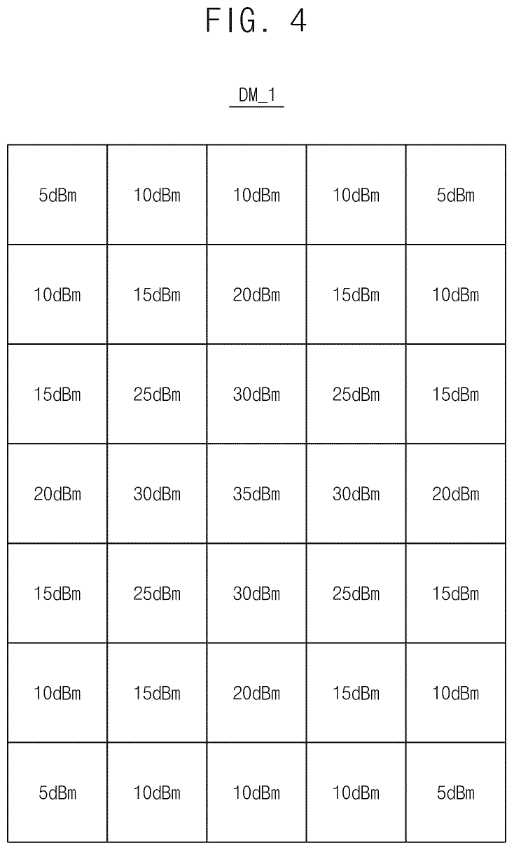

The connection setup circuit 120 obtains power distribution information (e.g., a power distribution diagram) for the plurality of rectennas 110 from the plurality of sub-AC powers SAP. Herein, the power distribution information may be referred to as a power distribution diagram. However, according to example embodiments the power distribution information may be in a form other than a diagram. For example, the power distribution diagram may include information related to the power magnitude of the plurality of sub-AC powers SAP received by the plurality of rectennas 110. Hereinafter, the power magnitude may be used in substantially the same meaning as power level or power density. A detailed configuration of the power distribution diagram will be described with reference to FIGS. 3 and 4.

The connection setup circuit 120 divides the plurality of rectennas 110 into a plurality of first groups, a plurality of second groups, and a plurality of third groups based on the power distribution diagram, a first reference value REFV1 and a second reference value REFV2. The plurality of first groups, the plurality of second groups, and the plurality of third groups include different numbers of rectennas. For example, the connection setup circuit 120 may divide the plurality of rectennas 110 into the plurality of first to third groups by comparing the power magnitude or power density of the plurality of sub-AC powers SAP with the first reference value REFV1 and the second reference value REFV2. For example, the first reference value REFV1 and the second reference value REFV2 may be set in advance in relation to a power required (or otherwise used) by the battery 150.

For example, the number of rectennas included in the plurality of first groups may be equal to each other, the number of rectennas included in the plurality of second groups may be equal to each other, and the number of rectennas included in the plurality of third groups may be equal to each other. For example, the number of rectennas included in each of the plurality of first groups, the number of rectennas included in each of the plurality of second groups, and the number of rectennas included in each of the plurality of third groups may be different from each other. For example, the number of rectennas included in each of the plurality of first groups may be one, the number of rectennas included in each of the plurality of second groups may be N, where N is an integer greater than or equal to two, and the number of rectennas included in each of the plurality of third groups may be M, where M is an integer greater than or equal to three. For example, M may be greater than the N.

A detailed operation of dividing the plurality of rectennas 110 will be described with reference to FIGS. 3 to 5.

The connection setup circuit 120 generates a control signal CONT for controlling a serial connection and a parallel connection of the plurality of sub-DC powers SDP based on the plurality of first to third groups. For example, the control signal CONT may control a connection state of the DC power combining circuit 130 so that the plurality of sub-DC powers SDP are connected in series and/or in parallel.

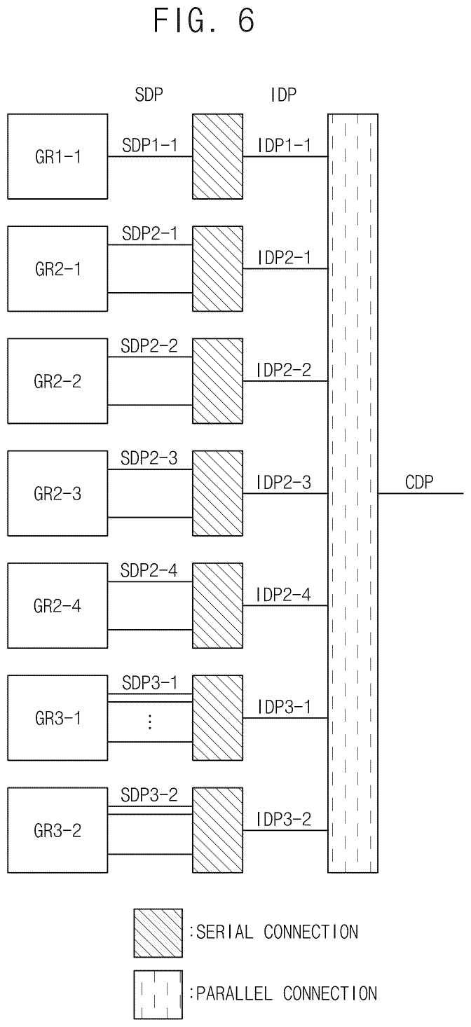

The DC power combining circuit 130 performs the series connection and the parallel connection for the plurality of sub-DC powers SDP based on the control signal CONT and performs a power synthesis based on the series connection and the parallel connection. For example, a combined DC power CDP having a power level approximate to a power level required (or otherwise used) by the battery 150 may be synthesized by the series connection and the parallel connection. The detailed operation of synthesizing the combined DC power CDP by the series connection and the parallel connection will be described with reference to FIGS. 6 to 8.

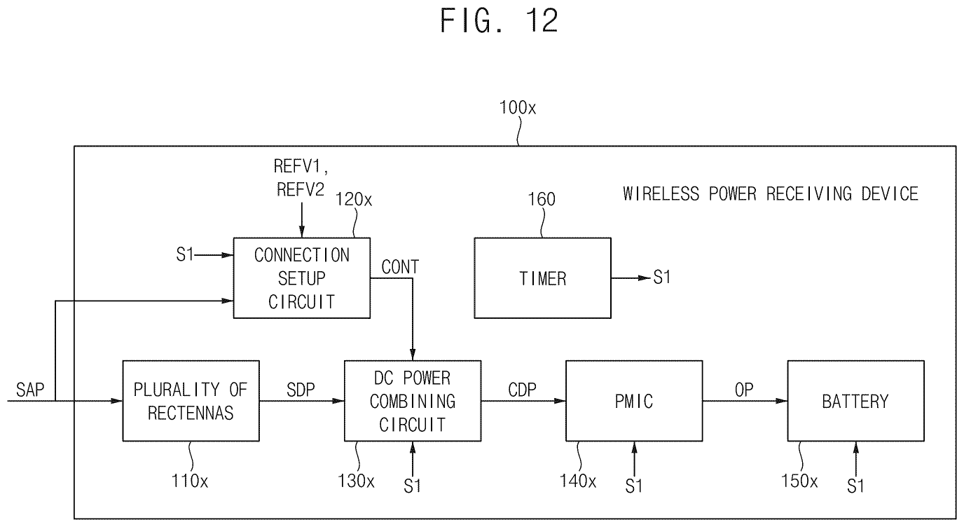

The PMIC 140 generates an output power OP based on the combined DC power CDP. For example, the PMIC 140 may represent a circuit that manages and controls a plurality of powers input to an electronic device (e.g., the wireless power receiving device 100) and distributes a power required for (or otherwise used by) a component (e.g., the battery 150) included in electronic device. For example, the PMIC 140 may supply the output power OP only when the battery 150 requests a power supply. Although not illustrated in FIG. 1, the PMIC 140 may receive a plurality of combined DC powers and charge a plurality of batteries. The plurality of combined DC powers and the plurality of batteries will be described with reference to FIG. 12.

The battery 150 stores the output power OP. For example, the battery 150 may be implemented based on various charging standards, and the first reference value REFV1 and the second reference value REFV2 may be set in advance according to the charging standards. For example, the battery 150 may be or may include a Lithium (Li)-ion battery.

The wireless power receiving device 100 may obtain the power distribution diagram based on the plurality of sub-AC powers SAP received by the plurality of rectennas 110. The wireless power receiving device 100 may efficiently obtain the target power by controlling the series connection and the parallel connection of the plurality of sub-DC powers SDP output from the plurality of rectennas 110 using the obtained power distribution diagram.

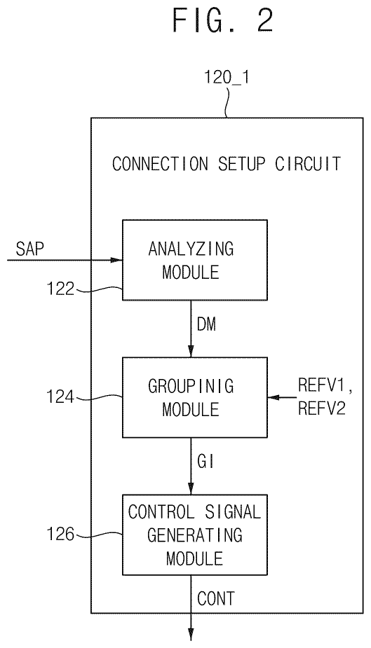

FIG. 2 is a block diagram illustrating a connection setup circuit included in a wireless power receiving device according to example embodiments.

Referring to FIG. 2, a connection setup circuit 120_1 may include an analyzing module 122, a grouping module 124, and/or a control signal generating module 126. The connection setup circuit 120_1 may be an example of the connection setup circuit 120 in FIG. 1.

The analyzing module 122 may obtain a power distribution diagram DM from the plurality of sub-AC powers SAP. For example, the analyzing module 122 may monitor the plurality of sub AC powers SAP received by the plurality of rectennas 110 in FIG. 1. For example, the power distribution diagram DM may include information about the magnitude of the plurality of sub-AC powers SAP.

Based on the power distribution diagram DM, the grouping module 124 may set one rectenna whose magnitude of received sub-AC power is greater than the first reference value REFV1 as one of the plurality of first groups. For example, the first group may include one rectenna whose magnitude of received sub-AC power is greater than the first reference value REFV1.

Based on the power distribution diagram DM, the grouping module 124 may set N rectennas whose magnitude of received sub-AC power is greater than the second reference value REFV2 and less than or equal to the first reference value REFV1 as one of the plurality of second groups. For example, the second group may include N rectennas whose magnitude of the received sub-AC power is greater than the second reference value REFV2 and less than or equal to the first reference value REFV1.

Based on the power distribution diagram DM, the grouping module 124 may set M rectennas whose magnitude of received sub-AC power is less than or equal to the second reference value REFV2 as one of a plurality of third groups. For example, the third group may include M rectennas whose magnitude of the received sub-AC power is less than or equal to the second reference value REFV2.

The grouping module 124 may generate grouping information GI related to the plurality of first to third groups. For example, the grouping information GI may include a location of each rectenna included in the plurality of first to third groups.

The control signal generating module 126 may generate the control signal CONT based on the grouping information GI. For example, a connection state of the DC power combining circuit 130 in FIG. 1 may be controlled based on the control signal CONT.

FIGS. 3, 4 and 5 are diagrams for describing an operation of dividing a plurality of rectennas.

Referring to FIGS. 3 to 5, a plurality of rectennas 110_1 may include 1st to 35th rectennas REC1, REC2, REC3, REC4, REC5, REC6, REC7, REC8, REC9, REC10, REC11, REC12, REC13, REC14, REC15, REC16, REC17, REC18, REC19, REC20, REC21, REC22, REC23, REC24, REC25, REC26, REC27, REC28, REC29, REC30, REC31, REC32, REC33, REC34 and REC35. The 1st to 35th rectennas REC1, REC2, . . . , REC35 may be divided into a plurality of first groups GR1, a plurality of second groups GR2 and a plurality of third groups GR3 based on a power distribution diagram DM_1, the first reference value REFV1, and the second reference value REFV2.

As illustrated in FIG. 3, the plurality of rectennas 110_1 may have an array structure. For example, each of the 1st to 35th rectennas REC1, REC2, . . . , REC35 may receive one of the plurality of sub-AC powers. Although FIG. 3 illustrates the wireless power receiving device 100 including thirty five rectennas, example embodiments are not limited thereto, and the operation of dividing the plurality of rectennas may be performed when the wireless power receiving device 100 includes more (or fewer) than thirty five rectennas.

As illustrated in FIG. 4, the power distribution diagram DM_1 may include information about the magnitude of the plurality of sub-AC powers received by the 1st to 35th rectennas REC1, REC2, . . . , REC35. For example, the magnitude of the plurality of sub AC powers may be calculated as an average power due to a characteristics of AC power. For example, the average power may represent an average power value during one cycle of an AC signal.

For example, a dBm unit may represent a log scale of watts (W). For example, about 1 W may be expressed as about 30 dBm, and about 0.1 W may be expressed as about 20 dBm. Although a magnitude of the plurality of sub-AC powers will be described in dBm units, example embodiments are not limited thereto, and the magnitude of the plurality of sub-AC powers may be expressed in W units or W/m\hat{ }2 units.

For example, when radio frequency power is received differently than when plane wave power is received, each of the 1st to 35th rectennas REC1, REC2, . . . , REC35 may receive power of various magnitudes. For example, the magnitude of the received sub-AC power may be maximum (or highest) at the 18th rectenna REC18 and may become smaller as a distance from the 18th rectenna REC18 increases. Although example embodiments are described based on the examples where the magnitude of the sub-AC powers is maximum (or highest) at the center of the array structure of the plurality of rectennas 110_1, and the magnitude of the sub-AC powers becomes smaller as the distance from the center of the array structure increases, example embodiments are not limited thereto, and the power distribution diagram DM_1 may be obtained differently depending on a characteristics of the plurality of sub-AC powers.

For convenience of illustration, although example embodiments are described based on the examples where a difference between sub-AC powers received by adjacent rectennas is about 5 dBm, example embodiments are not limited thereto, and the difference between sub-AC powers received by adjacent rectennas may be smaller than about 5 dBm.

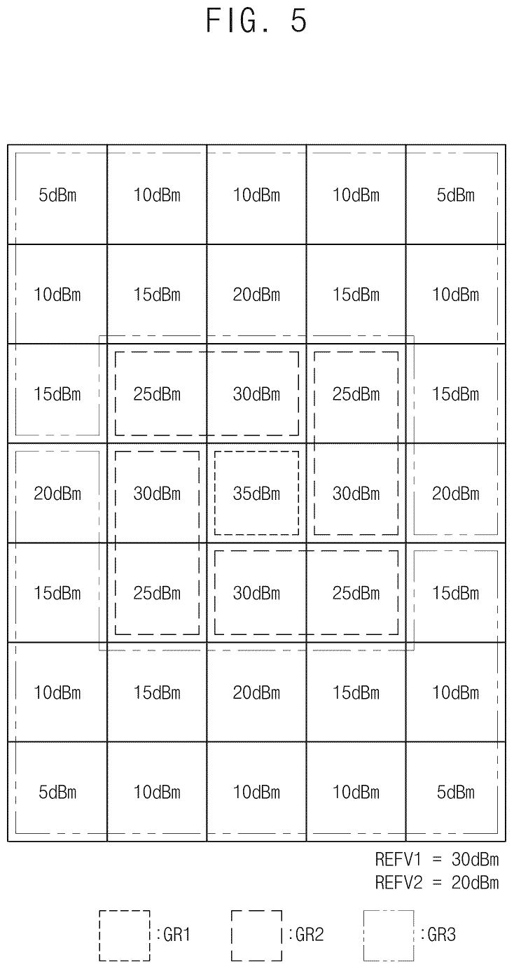

As illustrated in FIG. 5, the 1st to 35th rectennas REC1, REC2, . . . , REC35 may be divided into the plurality of first to third groups GR1, GR2 and GR3 according to the magnitude of the plurality of received sub-AC powers. Hereinafter, example embodiments will be described based on a scenario in which the first reference value REFV1 is about 30 dBm and the second reference value REFV2 is about 20 dBm.

For example, since the magnitude of the sub-AC power received by the 18th rectenna REC18 is greater than the first reference value REFV1, the 18th rectenna REC18 may be set as one of the plurality of first groups GR1. For example, the number of rectennas included in each of the plurality of first groups GR1 may be one. In FIG. 5, although example embodiments are described based on the examples where the number of the first groups GR1 is one (e.g., the number of groups included among the plurality of first groups GR1 is only one), example embodiments are not limited thereto, and the number of the first groups GR1 may be two or more. According to example embodiments, references herein to the plurality of first groups GR1 may refer to only one first group GR1 or more than one first group GR1.

For example, since the 12th, 13th, 14th, 17th, 19th, 22th, 23th and 24th rectennas REC12, REC13, REC14, REC17, REC19, REC22, REC23 and REC24 whose magnitude of received sub-AC power is greater than the second reference value REFV2 and less than or equal to the first reference value REFV1, the 12th, 13th, 14th, 17th, 19th, 22th, 23th and 24th rectennas REC12, REC13, REC14, REC17, REC19, REC22, REC23 and REC24 may be set as one of the plurality of second groups GR2. For example, the number of rectennas included in each of the plurality of second groups GR2 may be two. For example, the 12th and 13th rectennas REC12 and REC13 may be set as a 2-1st group among the plurality of second groups GR2. For example, the 14th and 19th rectennas REC14 and REC19 may be set as a 2-2nd group among the plurality of second groups GR2. For example, the 17th and 22nd rectenna REC17 and REC22 may be set as a 2-3rd group among the plurality of second groups GR2. For example, the 23rd and 24th rectennas REC23 and REC24 may be set as a 2-4th group among the plurality of second groups GR2.

However, example embodiments are not limited thereto, and the 12th and 17th rectennas REC12 and REC17 may be divided into the 2-1st group among the plurality of second groups GR2. Although example embodiments are described based on the examples where the number of rectennas included in each of the plurality of second groups GR2 is two, example embodiments are not limited thereto, and the number of rectennas included in each of the plurality of second groups GR2 may be N, where the N is an integer greater than or equal to two.

For example, since the 1st to 11th, 15th, 16th, 20th, 21th and 25th to 35th rectennas REC1, REC2, REC3, REC4, REC5, REC6, REC7, REC8, REC9, REC10, REC11, REC15, REC16, REC20, REC21, REC25, REC26, REC27, REC28, REC29, REC30, REC31, REC32, REC33, REC34 and REC35 whose magnitude of the received sub-AC power is less than or equal to the second reference value REFV2, the 1st to 11th, 15th, 16th, 20th, 21th and 25th to 35th rectennas REC1, REC2, REC3, REC4, REC5, REC6, REC7, REC8, REC9, REC10, REC11, REC15, REC16, REC20, REC21, REC25, REC26, REC27, REC28, REC29, REC30, REC31, REC32, REC33, REC34 and REC35 may be divided into one of the third groups GR3. For example, the number of rectennas included in each of the plurality of third groups GR3 may be thirteen. For example, the 1st to 11th, 15th, and 20th rectennas REC1, . . . , REC11, REC15 and REC20 may be divided into a 3-1st group among the plurality of third groups GR3. For example, the 16th, 21st and 25th to 35th rectennas REC16, REC21, REC25, . . . , REC35 may be divided into a 3-2nd group among the plurality of third groups GR3.

However, example embodiments are not limited thereto, and all the 1st to 11th, 15th, 16th, 20, 21 and 25th to 35th rectennas REC1, . . . , REC11, REC15, REC16, REC20, REC21, REC25, . . . , REC35 may be divided into one third group. Although example embodiments are described based on the examples where the number of rectennas included in each of the plurality of third groups GR3 is thirteen, example embodiments are not limited thereto, and the number of rectennas may be M, where M is an integer greater than or equal to three. For example, since the rectennas included in the plurality of third groups GR3 receive smaller amounts of power, the M may be set to be relatively large in relation to the N.

In example embodiments, although not illustrated, when the magnitude of the sub-AC power received by the 18th rectenna REC18 is larger (e.g., about 35 dBm or more), the 18th rectenna REC18 may be controlled so that the magnitude of the sub-DC power output by the 18th rectenna REC18 is reduced by a half.

FIGS. 6, 7 and 8 are diagrams for describing a series connection and a parallel connection of a plurality of sub-DC powers.

Referring to FIGS. 3 to 8, an example of the series connection and the parallel connection of the plurality of sub-DC powers SDP are illustrated based on a plurality of first groups GR1-1, a plurality of second groups GR2-1, GR2-2, GR2-3 and GR2-4, and a plurality of third groups GR3-1 and GR3-2. For example, a plurality of first to third intermediate DC powers IDP may be generated based on the plurality of sub-DC powers SDP, and the combined DC power CDP may be generated based on the plurality of first to third intermediate DC powers IDP.

The plurality of sub-DC powers SDP may include 1-1st, 2-1st, 2-2nd, 2-3rd, 2-4th, 3-1 st and 3-2nd sub-DC powers SDP1-1, SDP2-1, SDP2-2, SDP2-3, SDP2-4, SDP3-1 and SDP3-2. The plurality of first to third intermediate DC powers IDP may include 1-1st, 2-1st, 2-2nd, 2-3rd, 2-4th, 3-1st and 3-2nd intermediate DC powers IDP1-1, IDP2-1, IDP2-2, IDP2-3, IDP2-4, IDP3-1 and IDP3-2.

The 1-1st group GR1-1, the 2-1st group GR2-1, the 2-2nd group GR2-2, the 2-3rd group GR2-3, the 2-4th group GR2-4, the 3-1st group GR3-1 and the 3-2nd group GR3-2 are substantially the same as those described with reference to FIG. 5.

For example, the 1-1st intermediate DC power IDP1-1 may be generated from the 1-1st sub-DC power SDP1-1. For example, the 1-1st sub-DC power SDP1-1 may represent the sub-DC power output by the 18th rectenna REC18 included in the 1-1st group GR1-1. For example, the 1-1 st intermediate DC power IDP1-1 may be the same as (or similar to) the 1-1st sub-DC power SDP1-1.

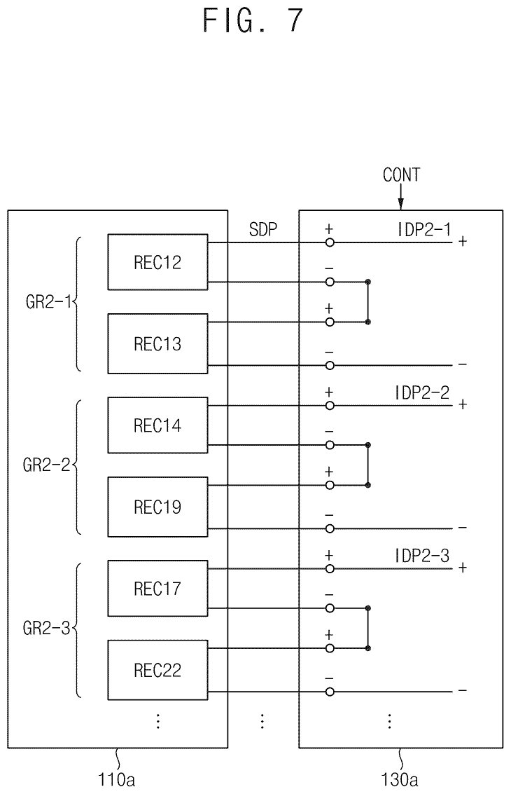

For example, the 2-1st intermediate DC power IDP2-1 may be generated from the 2-1 st sub-DC powers SDP2-1. For example, the 2-1st sub-DC powers SDP2-1 may represent the sub-DC powers SDP output by the 12th and 13th rectenna REC12 and REC13 included in the 2-1st group GR2-1. For example, the 2-1st intermediate DC power IDP2-1 may be generated by connecting each of the 2-1st sub-DC powers SDP2-1 in series. For example, the 2-1st intermediate DC power IDP2-1 may be generated by connecting the two sub-DC powers output from the 12th and 13th rectennas REC12 and REC13 in series. The series connection will be described with reference to FIG. 7.

For example, like the 2-1st intermediate DC power IDP2-1, the 2-2nd intermediate DC power IDP2-2 may be generated by connecting the 2-2nd sub-DC powers SDP2-1 in series. For example, like the 2-1st intermediate DC power IDP2-1, the 2-3rd intermediate DC power IDP2-3 may be generated by connecting the 2-3rd sub-DC powers SDP2-3 in series. For example, like the 2-1 st intermediate DC power IDP2-1, the 2-4th intermediate DC power IDP2-4 may be generated by connecting the 2-4th sub-DC powers SDP2-4 in series.

For example, the 3-1st intermediate DC power IDP3-1 may be generated from the 3-1st sub-DC powers SDP3-1. For example, the 3-1st sub-DC powers SDP3-1 may represent the sub-DC powers SDP output by 1st to 11th, 15th and 20th rectennas REC1, . . . , REC11, REC15 and REC20. For example, the 3-1st intermediate DC power IDP3-1 may be generated by connecting each of the 3-1st sub-DC powers SDP3-1 in series. For example, the 3-1st intermediate DC power IDP3-1 may be generated by connecting the thirteen sub-DC powers output by the 1st to 11th, 15th and 20th rectennas REC1, . . . , REC11, REC15 and REC20 in series.

For example, like the 3-1 st intermediate DC power IDP3-1, the 3-2nd intermediate DC power IDP3-2 may be generated by connecting the 3-2nd sub-DC powers SDP3-2 in series.

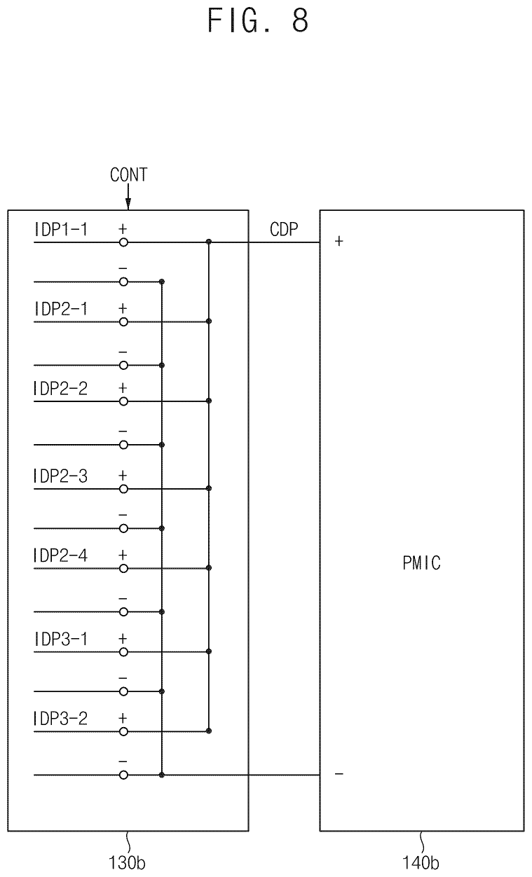

For example, the combined DC power CDP may be generated from the 1-1st, 2-1st, 2-2nd, 2-3rd, 2-4th, 3-1st and 3-2nd intermediate DC powers IDP1-1, IDP2-1, IDP2-2, IDP2-3, IDP2-4, IDP3-1 and IDP3-2. For example, the combined DC power CDP may be generated by connecting the 1-1st, 2-1st, 2-2nd, 2-3rd, 2-4th, 3-1st and 3-2nd intermediate DC powers IDP1-1, IDP2-1, IDP2-2, IDP2-3, IDP2-4, IDP3-1 and IDP3-2 in parallel. The parallel connection will be described with reference to FIG. 8.

As illustrated in FIG. 7, a DC power combining circuit 130a may connect the plurality of sub-DC powers SDP in series. Hereinafter, only some of the plurality of second groups GR2-1, GR2-2 and GR2-3 among the plurality of rectennas 110a will be described.

For example, the 12th, 13th, 14th, 17th, 19th and 22nd rectenna REC12, REC13, REC14, REC17, REC19 and REC22 may each include one + terminal and one − terminal. For example, the series connection and the parallel connection may be performed depending on the connection relationship between the + terminal and the − terminal of each rectenna. For example, in the 2-1st group GR2-1, the 2-1st intermediate DC power IDP2-1 may be generated by connecting the + terminal of the 13th rectenna REC13 and the − terminal of the 12th rectenna REC12. For example, in the 2-2nd group GR2-2, the 2-2nd intermediate DC power IDP2-2 may be generated by connecting the + terminal of the 19th rectenna REC19 and the − terminal of the 14th rectenna REC14. For example, in the 2-3rd group GR2-3, the 2-3rd intermediate DC power IDP2-3 may be generated by connecting the + terminal of the 22nd rectenna REC22 and the − terminal of the 17th rectenna REC17.

As illustrated in FIG. 8, a DC power combining circuit 130b may connect the plurality of first to third intermediate DC powers IDP in parallel. The combined DC power CDP generated by connecting the plurality of first to third intermediate DC powers IDP in parallel may be provided to a PMIC 140b.

For example, when the + terminals related to the plurality of first to third intermediate DC powers IDP are connected to each other, and the − terminals related to the plurality of first to third intermediate DC powers IDP are connected to each other, the parallel connection of the plurality of first to third intermediate DC powers IDP may be performed.

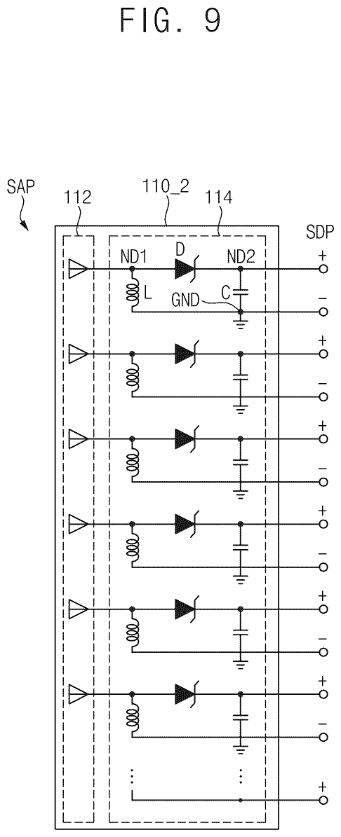

FIG. 9 is a circuit diagram illustrating an example of a plurality of rectennas included in a wireless power receiving device according to example embodiments.

Referring to FIG. 9, a plurality of rectennas 110_2 may include a plurality of antenna elements 112 and a plurality of rectifier circuits 114. The plurality of rectennas 110_2 may represent an example of the plurality of rectennas 110 in FIG. 1.

The plurality of antenna elements 112 may receive the plurality of sub AC powers. For example, the plurality of antenna elements 112 may each transmit or receive electromagnetic waves of a specific frequency. For example, the electromagnetic wave of the specific frequency may include the plurality of sub AC powers.

The plurality of rectifier circuits 114 may be connected (e.g., respectively connected) to the plurality of antenna elements 112 and may convert the plurality of sub-AC powers SAP into the plurality of sub-DC powers SDP. For example, the plurality of rectifier circuits 114 may be implemented as various voltage doubler rectifiers.

Each of the plurality of rectifier circuits 114 may include a diode D, a capacitor C, and/or an inductor L. For example, the diode D may be connected between a first node ND1 and a second node ND2. For example, the first node ND1 may represent an output terminal of one of the plurality of antenna elements 112. For example, an input terminal of the diode D may be connected to the first node ND1, and an output terminal of the diode D may be connected to the second node ND2. For example, the diode D may represent a device that converts an AC signal into a DC signal. For example, the capacitor C may be connected between the second node ND2 and a ground node GND. For example, the capacitor C may remove a ripple of the DC signal output from the diode D. For example, the inductor L may be connected between the first node ND1 and the ground node GND.

Each of the plurality of rectifier circuits 114 may include the inductor L for impedance matching, but example embodiments are not limited thereto, and each of the plurality of rectifier circuits 114 may not include the inductor L. Although in FIG. 9, example embodiments are described based on the examples where each of the plurality of rectifier circuits 114 is composed of one diode and one capacitor, example embodiments are not limited thereto, and each of the plurality of rectifier circuits 114 may be composed of two or more diodes and two or more capacitors.

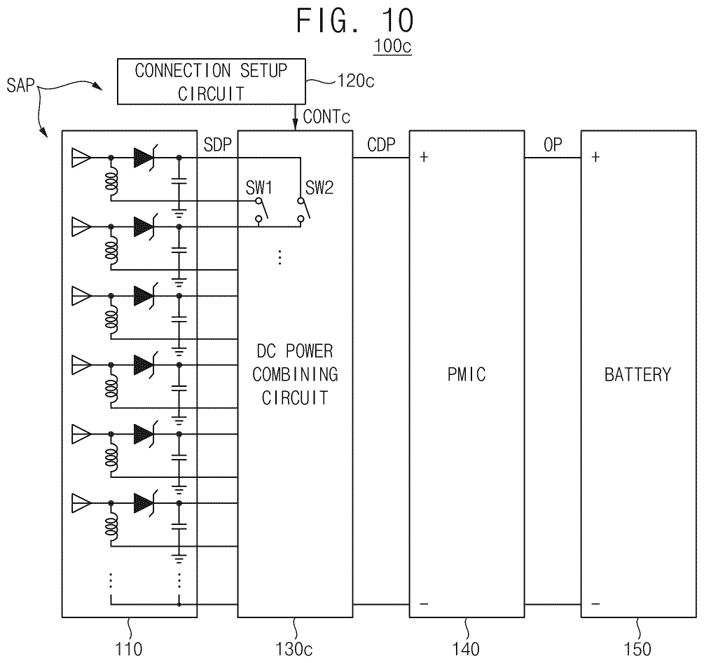

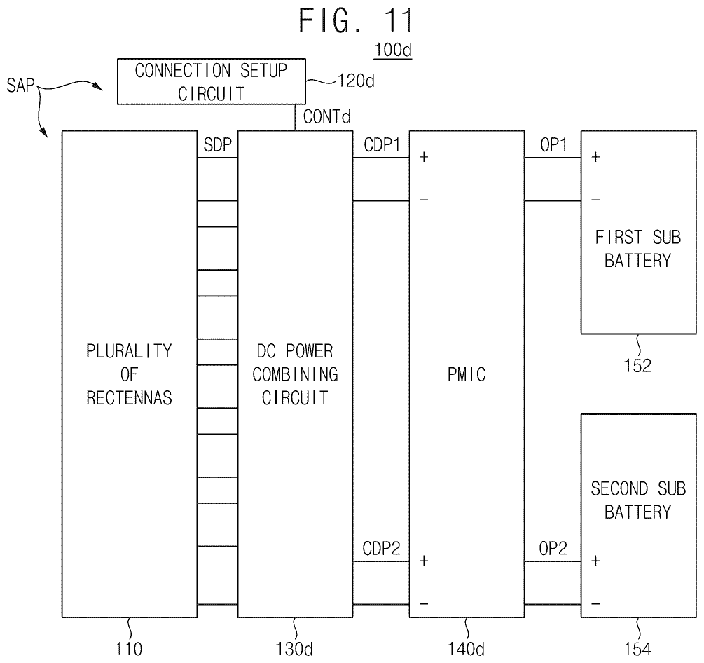

FIGS. 10 and 11 are diagrams illustrating examples of wireless power receiving devices according to example embodiments.

Referring to FIG. 10, a wireless power receiving device 100c may include the plurality of rectennas 110, a connection setup circuit 120c, a DC power combining circuit 130c, the PMIC 140, and/or the battery 150. The wireless power receiving device 100c may represent an example of the wireless power receiving device 100 of FIG. 1. The descriptions repeated with or overlapping with descriptions of FIG. 1 will be omitted in the interest of brevity.

In example embodiments, the DC power combining circuit 130c may include a plurality of switches SW1, SW2, . . . . For example, the series connections and the parallel connections of the plurality of sub-DC powers SDP may be performed based on an activation and/or a deactivation of the plurality of switches SW1, SW2, . . . . For example, the connection setup circuit 120c may generate a control signal CONTc that controls an operation (e.g., the activation and the deactivation) of the plurality of switches SW1, SW2, . . . . For example, even when a charging standard of the battery 150 changes, the wireless power receiving device 100c may generate the output power OP through a change in the control signal CONTc. According to example embodiments, the wireless power receiving device 100c may adapt to changing charging standards by adjusting the first reference value REFV1 and the second reference value REFV2.

Referring to FIG. 11, a wireless power receiving device 100d may include the plurality of rectennas 110, a connection setup circuit 120d, a DC power combining circuit 130d, a PMIC 140d, a first sub-battery 152 and/or a second sub-battery 154. The first sub-battery 152 and the second sub-battery 154 may be included in the battery 150 in FIG. 1. The wireless power receiving device 100d may represent an example of the wireless power receiving device 100 of FIG. 1. The descriptions repeated with or overlapping with descriptions of FIG. 1 will be omitted in the interest of brevity.

For example, the combined DC power CDP in FIG. 1 may include a first combined DC power CDP1 and a second combined DC power CDP2. For example, the first combined DC power CDP1 may have a power level that is close to the power level required (or otherwise used) by the first sub-battery 152. For example, the second combined DC power CDP2 may have a power level that is close to the power level required (or otherwise used) by the second sub-battery 154.

For example, the first combined DC power CDP1 may be generated by connecting the plurality of first intermediate DC powers IDP1-1 and the plurality of second intermediate DC powers IDP2-1, IDP2-2, IDP2-3 and IDP2-4 in parallel. For example, further referring to FIG. 8, the first combined DC power CDP1 may be generated by connecting the plurality of first intermediate DC powers IDP1-1 and the plurality of second intermediate DC powers IDP2-1, IDP2-2, IDP2-3 and IDP2-4 in parallel. According to example embodiments, the plurality of first intermediate DC powers ISP1-1 may refer to only one first intermediate DC power ISP1-1 (e.g., in implementations in which the number of first groups GR1 is one) or more than one first intermediate DC power ISP1-1.

For example, the second combined DC power CDP2 may be generated by connecting the plurality of third intermediate DC powers IDP3-1 and IDP3-2 in parallel. For example, further referring to FIG. 8, the second combined DC power CDP2 may be generated by connecting the plurality of third intermediate DC powers IDP3-1 and IDP3-2 in parallel.

For example, the PMIC 140d may generate a first output power OP1 based on the first combined DC power CDP1, and may generate a second output power OP2 based on the second combined DC power CDP2.

For example, the first sub-battery 152 may store the first output power OP1, and the second sub-battery 154 may store the second output power OP2. For example, the wireless power receiving device 100d may charge two or more batteries simultaneously (or contemporaneously).

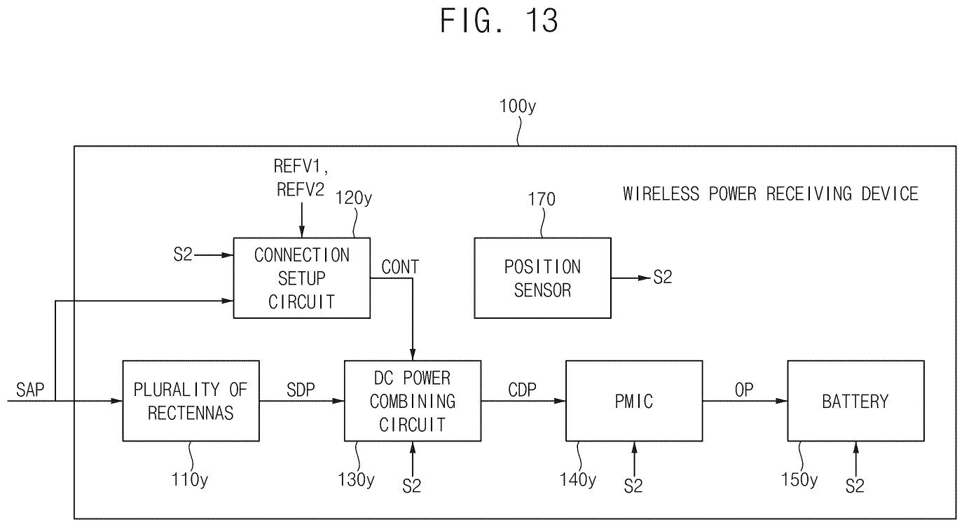

FIGS. 12 and 13 are block diagrams illustrating examples of wireless power receiving devices according to example embodiments.

Referring to FIG. 12, a wireless power receiving device 100x may include a plurality of rectennas 110x, a connection setup circuit 120x, a DC power combining circuit 130x, a power management circuit 140x, a battery 150x and/or a timer 160. The wireless power receiving device 100x may represent an example of the wireless power receiving device 100 of FIG. 1. The descriptions repeated with or overlapping with descriptions of FIG. 1 will be omitted in the interest of brevity.

The timer 160 may generate a first signal S1 at regular time intervals. Based on the first signal S1, the operation of obtaining the power distribution diagram DM, the operation of dividing the plurality of rectennas 110x, the operation of generating the control signal CONT, the operation of generating combined direct current power CDP, and/or the operation of generating the output power OP may be performed periodically. For example, the wireless power receiving device 100x may perform the series connection and the parallel connection optimized for power distribution (or providing more efficient power distribution) at regular time intervals.

Referring to FIG. 13, a wireless power receiving device 100y may include a plurality of rectennas 110y, a connection setup circuit 120y, a DC power combining circuit 130y, a PMIC 140y, a battery 150y, and/or a position sensor 170. The wireless power receiving device 100y may represent an example of the wireless power receiving device 100 of FIG. 1. The descriptions repeated with or overlapping with descriptions of FIG. 1 will be omitted in the interest of brevity.

The position sensor 170 may generate a second signal S2 when a change in the position of the wireless power receiving device 100y is detected. Based on the second signal S2, the operation of obtaining the power distribution diagram DM, the operation of dividing the plurality of rectennas 110y, the operation of generating the control signal CONT, the operation of generating combined DC power CDP, and/or the operation of generating the output power OP may be performed whenever the position of the wireless power receiving device 100y changes (e.g., in response to detecting a change in the position of the wireless power receiving device 100y). For example, the wireless power receiving device 100y may perform the series connection and the parallel connection optimized for power distribution (or providing more efficient power distribution) according to the relative position with the wireless power transmitting device.

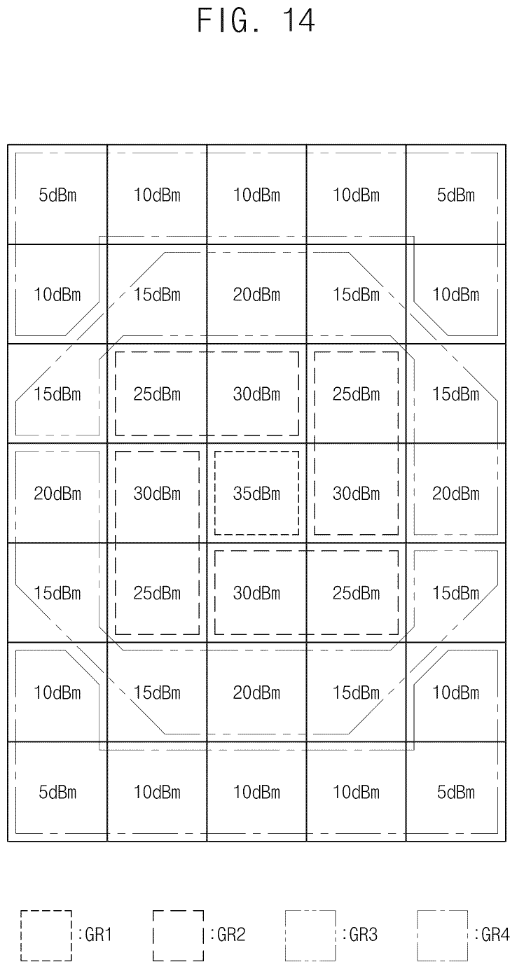

FIG. 14 is a diagram illustrating an example of an operation of dividing a plurality of rectennas.

Referring to FIGS. 3, 4 and 14, the 1st to 35th rectennas REC1, REC2, . . . , and REC35 may be divided into the plurality of first to fourth groups GR1, GR2, GR3 and GR4 according to the magnitude of the plurality of AC powers received. For example, FIG. 14 may illustrate an example of additionally dividing the plurality of fourth groups GR4 in the dividing operation of FIG. 5. The descriptions repeated with or overlapping with descriptions of FIG. 5 will be omitted in the interest of brevity.

For example, the connection setup circuit 120 may divide the 1st to 35th rectennas REC1, REC2, . . . , REC35 into the plurality of first to fourth groups GR1, GR2, GR3 and GR4 based on the power distribution diagram DM_1, the first reference value REFV1, the second reference value REFV2 and the third reference value REFV3. For example, the connection setup circuit 120 may generate the control signal CONT based on the plurality of first to fourth groups GR1, GR2, GR3 and GR4.

For example, since the magnitude of the received sub-AC power by the 7th, 8th, 9th, 11th, 15th and 20th rectennas REC7, REC8, REC9, REC11, REC15 and REC20 is greater than the third reference value REFV3 and less than or equal to the second reference value REFV2, the 7th, 8th, 9th, 11th, 15th and 20th rectennas REC7, REC8, REC9, REC11, REC15 and REC20 may be divided into one of the plurality of third groups GR3. For example, the number of rectennas included in each of the plurality of third groups GR3 may be six.

For example, since the magnitude of the received sub-AC power by each of the 1st to 6th and 10th rectennas REC1, . . . , REC6 and REC10 is less than or equal to the third reference value REFV3, the 1st to 6th and 10th rectenna REC1, . . . , REC6 and REC10 may be divided into one of the plurality of fourth groups GR4. For example, the number of rectennas included in each of the plurality of fourth groups GR4 may be seven. Although example embodiments are described based on the examples where the number of rectennas included in each of the plurality of fourth groups GR4 is seven, example embodiments are not limited thereto, and the number of rectennas included in each of the plurality of fourth groups GR4 may be K, where the K is an integer greater than or equal to four.

Although example embodiments are described based on the examples where the plurality of rectennas are divided into the plurality of first to third groups or the plurality of first to fourth groups, example embodiments are not limited thereto, and the plurality of rectennas may be divided into a plurality of first to Pth groups, where the P is an integer greater than or equal to three.

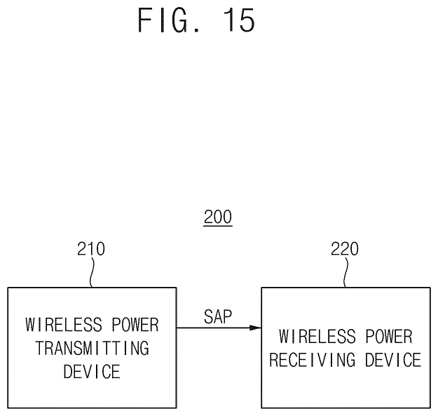

FIG. 15 is a diagram illustrating a wireless power transmission and reception system including a wireless power receiving device according to example embodiments.

Referring to FIG. 15, a wireless power transmission and reception system 200 may include a wireless power transmission device 210 and a wireless power receiving device 220.

The wireless power transmission device 210 may transmit the plurality of sub-AC powers SAP. For example, the plurality of sub-AC powers SAP may be efficient radio frequency power (RF power).

The wireless power receiving device 220 may receive the plurality of sub-AC powers SAP and may perform a charging operation, etc. The wireless power receiving device 220 may be the wireless power receiving device according to example embodiments described with reference to FIGS. 1 to 14 (e.g., the wireless power receiving device 100).

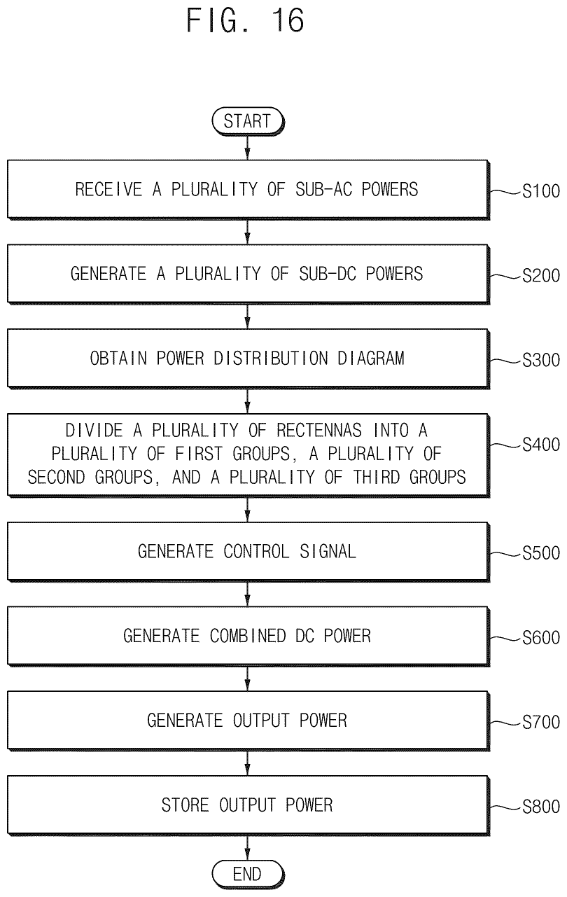

FIG. 16 is a flowchart illustrating a method of operating a wireless power receiving device according to example embodiments.

Referring to FIG. 16, operations S100 to S800 may be performed by a wireless power receiving device. The wireless power receiving device may include a plurality of rectennas, a connection setup circuit, a DC power combining circuit, a PMIC, and/or a battery. The wireless power receiving device may be the wireless power receiving device according to example embodiments described with reference to FIGS. 1 to 14 (e.g., the wireless power receiving device 100). The descriptions repeated with or overlapping with descriptions of FIG. 1 will be omitted in the interest of brevity.

The plurality of rectennas receive a plurality of sub-AC powers (operation S100). For example, the plurality of rectennas may include a plurality of antenna elements and may receive the plurality of sub-AC powers through the plurality of antenna elements.

The plurality of rectennas generate a plurality of sub-DC powers based on the plurality of sub-AC powers (operation S200). For example, the plurality of rectennas may include a plurality of rectifier circuits and may generate the plurality of sub-DC powers through the plurality of rectifier circuits.

The connection setup circuit obtains a power distribution diagram for the plurality of rectennas from the plurality of sub-AC powers (operation S300). For example, the power distribution diagram may include information about a magnitude of the plurality of sub-AC powers received by the plurality of rectennas.

The connection setup circuit divides the plurality of rectennas into a plurality of first to third groups based on the power distribution diagram, a first reference value and a second reference value (operation S400). The plurality of first groups, the plurality of second groups and the plurality of third groups may include different numbers of rectennas. For example, the plurality of first groups may include one rectenna, the plurality of second groups may include N rectennas, where the N is an integer greater than or equal to two, and the plurality of third groups may include M rectennas, where the Mis an integer greater than or equal to three.

The connection setup circuit generates a control signal based on the first to third plurality of groups (operation S500). The DC power combining circuit generates combined DC power based on the control signal (operation S600). The control signal controls a series connection and a parallel connection of the plurality of sub-DC powers. For example, the control signal may change the connection state of the DC power combining circuit. For example, the series connection and the parallel connection of the plurality of sub-DC powers may be determined depending on the connection state of the DC power combining circuit.

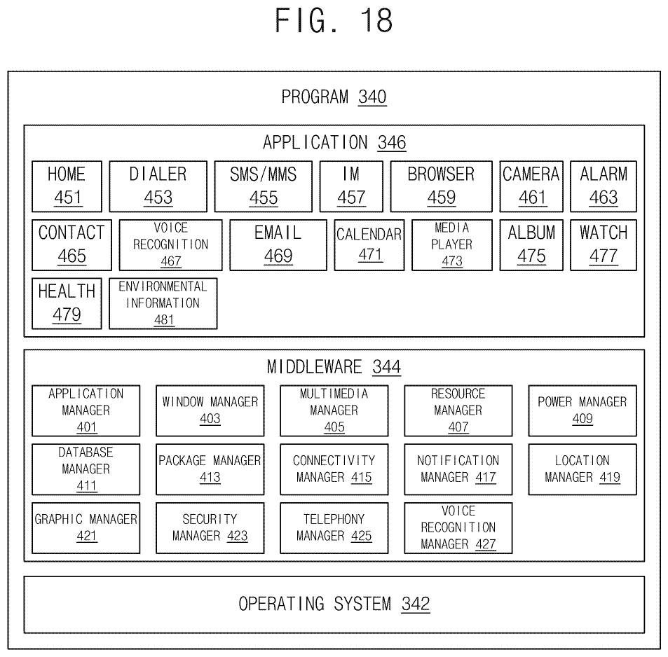

The PMIC generates an output power based on the combined DC power (operation S700). The battery stores the output power (operation S800). For example, the output power may have a charging standard required (or otherwise used) by the battery. According to example embodiments, in operation S800 the battery may be charged using the output power. According to example embodiments, during and/or following charging of the battery in operation S800, an electronic device (e.g., the electronic device 301 discussed below) including the wireless power receiving device (or the wireless power receiving device itself) may draw power from the battery to perform processing operations. The processing operations may include, for example, activating a display, executing one or more programs (e.g., the program 340 discussed in connection with FIG. 18), etc.

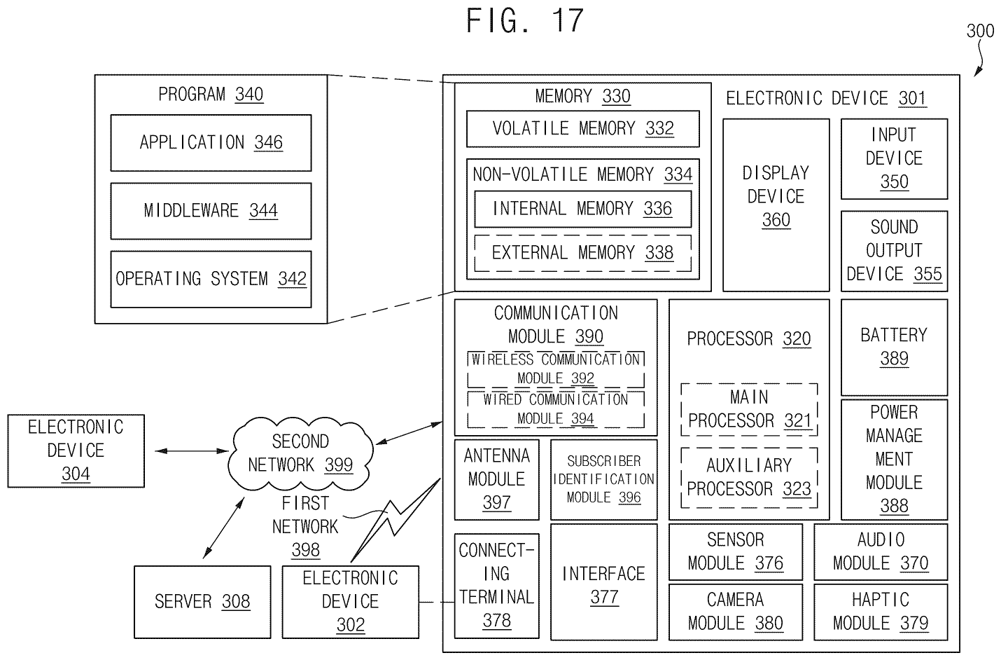

FIG. 17 is a block diagram illustrating an electronic device according to example embodiments in a network environment.

Referring to FIG. 17, an electronic device 301 in a network environment 300 may communicate with an electronic device 302 via a first network 398 (e.g., a short-range wireless communication network), or an electronic device 304 or a server 308 via a second network 399 (e.g., a long-range wireless communication network). For example, the electronic device 301 may communicate with the electronic device 304 via the server 308. For example, the electronic device 301 may include a processor 320, a memory 330, an input device 350, a sound output device 355, a display device 360, an audio module 370, a sensor module 376, an interface 377, a haptic module 379, a camera module 380, a power management module 388, a battery 389, a communication module 390, a subscriber identification module (SIM) 396, and/or an antenna module 397. In example embodiments, at least one (e.g., the display device 360 or the camera module 380) of the components may be omitted from the electronic device 301, or one or more other components may be added in the electronic device 301. In example embodiments, some of the components may be implemented as single integrated circuitry. For example, the sensor module 376 (e.g., a fingerprint sensor, an iris sensor, or an illuminance sensor) may be implemented as embedded in the display device 360 (e.g., a display). According to example embodiments, two or more (or all) of the components of the electronic device 301 illustrated in FIG. 17 may be configured to communicate (e.g., bi-directionally communicate) with one another (e.g., via at least one bus, not depicted).

The processor 320 may execute, for example, software (e.g., a program 340) to control at least one other component (e.g., a hardware or software component) of the electronic device 301 coupled with the processor 320, and may perform various data processing or computation. For example, as at least part of the data processing or computation, the processor 320 may load a command or data received from another component (e.g., the sensor module 376 or the communication module 390) in a volatile memory 332, process the command or the data stored in the volatile memory 332, and store resulting data in a nonvolatile memory 334. In example embodiments, the processor 320 may include a main processor 321 (e.g., a central processing unit (CPU) or an application processor (AP)), and an auxiliary processor 323 (e.g., a graphics processing unit (GPU), an image signal processor (ISP), a sensor hub processor, or a communication processor (CP)) that is operable independently from, or in conjunction with, the main processor 321. Additionally or alternatively, the auxiliary processor 323 may be adapted to consume less power than the main processor 321, or to be specific to a specified function. The auxiliary processor 323 may be implemented as separate from, or as part of the main processor 321.

The auxiliary processor 323 may control at least some of functions or states related to at least one component (e.g., the display device 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). In example embodiments, the auxiliary processor 323 (e.g., an image signal processor or a communication processor) may be implemented as part of another component (e.g., the camera module 380 or the communication module 390) functionally related to the auxiliary processor 323.

The memory 330 may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 and/or the nonvolatile memory 334.

The program 340 may be stored in the memory 330 as software, and may include, for example, an operating system (OS) 342, middleware 344, and/or an application 346.

The input device 350 may receive a command or data to be used by another component (e.g., the processor 320) of the electronic device 301, from the outside (e.g., a user) of the electronic device 301. The input device 350 may include, for example, a microphone, a mouse, a keyboard, or a digital pen (e.g., a stylus pen).

The sound output device 355 may output sound signals to the outside of the electronic device 301. The sound output device 355 may include, for example, a speaker or a receiver. The speaker may be used for general purposes, such as playing multimedia or playing record, and the receiver may be used for an incoming calls. In example embodiments, the receiver may be implemented as separate from, or as part of the speaker.

The display device 360 may visually provide information to the outside (e.g., a user) of the electronic device 301. The display device 360 may include, for example, a display, a hologram device, or a projector and control circuitry to control a corresponding one of the display, hologram device, and projector. In example embodiments, the display device 360 may include touch circuitry adapted to detect a touch, or sensor circuitry (e.g., a pressure sensor) adapted to measure the intensity of force incurred by the touch.

The audio module 370 may convert a sound into an electrical signal and vice versa. In example embodiments, the audio module 370 may obtain the sound via the input device 350, or output the sound via the sound output device 355 or a headphone of an external electronic device (e.g., an electronic device 302) directly (e.g., wired) or wirelessly coupled with the electronic device 301.

The sensor module 376 may detect an operational state (e.g., power or temperature) of the electronic device 301 or an environmental state (e.g., a state of a user) external to the electronic device 301, and then generate an electrical signal or data value corresponding to the detected state. In example embodiments, the sensor module 376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 377 may support one or more specified protocols to be used for the electronic device 301 to be coupled with the external electronic device (e.g., the electronic device 302) directly (e.g., wired) or wirelessly. In example embodiments, the interface 377 may include, for example, a high definition multimedia interface (HDMI), a universal serial bus (USB) interface, a secure digital (SD) card interface, and/or an audio interface.

A connecting terminal 378 may include a connector via which the electronic device 301 may be physically connected with the external electronic device (e.g., the electronic device 302). In example embodiments, the connecting terminal 378 may include, for example, a HDMI connector, a USB connector, a SD card connector, and/or an audio connector (e.g., a headphone connector).

The haptic module 379 may convert an electrical signal into a mechanical stimulus (e.g., a vibration or a movement) or electrical stimulus which may be recognized by a user via his tactile sensation or kinesthetic sensation. In example embodiments, the haptic module 379 may include, for example, a motor, a piezoelectric element, and/or an electric stimulator.

The camera module 380 may capture a still image or moving images. In example embodiments, the camera module 380 may include one or more lenses, image sensors, image signal processors, and/or flashes.

The power management module 388 may include the connection setup circuit, the DC power combining circuit, and the PMIC included in the wireless power receiving device according to example embodiments described with reference to FIGS. 1 to 16. The power management module 388 may manage power supplied to the electronic device 301. In example embodiments, the power management module 388 may be implemented as at least part of, for example, a PMIC.

The battery 389 may include the battery included in the wireless power receiving device according to example embodiments described with reference to FIGS. 1 to 16. The battery 389 may supply power to at least one component of the electronic device 301. In example embodiments, the battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more communication processors that are operable independently from the processor 320 (e.g., the application processor (AP)) and supports a direct (e.g., wired) communication or a wireless communication. In example embodiments, the communication module 390 may include a wireless communication module 392 (e.g., a cellular communication module, a short-range wireless communication module, or a global navigation satellite system (GNSS) communication module) and/or a wired communication module 394 (e.g., a local area network (LAN) communication module or a power line communication (PLC) module). A corresponding one of these communication modules may communicate with the external electronic device via the first network 398 (e.g., a short-range communication network, such as Bluetooth™, wireless-fidelity (Wi-Fi) direct, or infrared data association (IrDA)) or the second network 399 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 392 may identify and authenticate the electronic device 301 in a communication network, such as the first network 398 or the second network 399, using subscriber information (e.g., international mobile subscriber identity (IMSI)) stored in the subscriber identification module 396.

The antenna module 397 may include the plurality of rectennas included in the wireless power receiving device according to example embodiments described with reference to FIGS. 1 to 16. The antenna module 397 may transmit or receive a signal or power to or from the outside (e.g., the external electronic device) of the electronic device 301. In example embodiments, the antenna module 397 may include an antenna including a radiating element composed of a conductive material or a conductive pattern formed in or on a substrate (e.g., PCB). In example embodiments, the antenna module 397 may include a plurality of antennas. In such a case, at least one antenna appropriate for a communication scheme used in the communication network, such as the first network 398 or the second network 399, may be selected, for example, by the communication module 390 (e.g., the wireless communication module 392) from the plurality of antennas. The signal or the power may then be transmitted or received between the communication module 390 and the external electronic device via the selected at least one antenna. In example embodiments, another component (e.g., a radio frequency integrated circuit (RFIC)) other than the radiating element may be additionally formed as part of the antenna module 397.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In example embodiments, commands or data may be transmitted or received between the electronic device 301 and the external electronic device 304 via the server 308 coupled with the second network 399. Each of the electronic devices 302 and 304 may be a device of a same type as, or a different type, from the electronic device 301. In example embodiments, all or some of operations to be executed at the electronic device 301 may be executed at one or more of the external electronic devices 302, 304 or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 301. The electronic device 301 may provide the outcome, with or without further processing of the outcome, as at least part of a reply to the request. To that end, a cloud computing, distributed computing, or client-server computing technology may be used, for example.

The electronic device according to example embodiments may be one of various types of electronic devices. The electronic devices may include, for example, a portable communication device (e.g., a smartphone), a computer device, a portable multimedia device, a portable medical device, a camera, a wearable device, or a home appliance. In example embodiments, the electronic devices are not limited to those described above.

FIG. 18 is a block diagram illustrating an example of a program included in an electronic device of FIG. 17.

Referring to FIG. 18, the program 340 may include the operating system 342 for controlling one or more resources of the electronic device 301, the middleware 344, or the application 346 executable on the operating system 342. For example, the operating system 342 may include Android®, iOS®, Windows®, Symbian®, Tizen® or Bada™. At least some of the programs 340 may be preloaded into the electronic device 301, for example, during manufacturing, may be stored in an external electronic device (e.g., the electronic device 302 or 304) in the user's usage environment or may be downloaded or updated from the server 308.

The operating system 342 may control (e.g., allocate or reclaim) system resources (e.g., processes, memory, or power) of the electronic device 301. The operating system 342 may additionally or alternatively include the other hardware devices of the electronic device 301, such as the input device 350, the sound output device 355, the display device 360, the audio module 370, the sensor module 376, the interface 377, the haptic module 379, the camera module 380, the power management module 388, the battery 389, the communication module 390, the subscriber identification module 396, or one or more driver programs for driving the antenna module 397.

The middleware 344 may provide various functions to the application 346 so that the application 346 may use functions or information provided by one or more resources of the electronic device 301. The middleware 344 may include, for example, an application manager 401, a window manager 403, a multimedia manager 405, a resource manager 407, a power manager 409, a database manager 411, a package manager 413, a connectivity manager 415, a notification manager 417, a location manager 419, a graphic manager 421, a security manager 423, a telephony manager 425, or a speech recognition manager 427, etc.

The application manager 401 may, for example, manage the life cycle of the application 346. The window manager 403 may, for example, manage GUI (graphical user interface) resources used on the screen. The multimedia manager 405 may, for example determine the format required (or otherwise used) to play media files and encode or decode the media files using a codec suitable for the format. The resource manager 407 may, for example, manage the source code or memory space of the application 346. The power manager 409 may, for example, manage battery capacity, temperature, or power, and may use this information to determine or provide power information necessary (or otherwise used) for the operation of the electronic device 301. In example embodiments, the power manager 409 may interface with a basic input/output system (BIOS).

The database manager 411 may, for example, create, search, or change the database to be used in the application 346. The package manager 413 may, for example, manage the installation or update of applications distributed in the form of package files. The connectivity manager 415 may, for example, manage a wireless or wired connection between the electronic device 301 and an external electronic device. The notification manager 417 may, for example, provide a function for notifying the user of an event that has occurred (e.g., a call, a message, or an alarm). The location manager 419 may, for example, manage location information of the electronic device 301. The graphics manager 421 may, for example, manage graphic effects to be provided to users or user interfaces related thereto.

The security manager 423 may, for example, provide system security or user authentication. The call manager 425 may, for example, manage the voice call or video call function of the electronic device 301. The voice recognition manager 427 may, for example, transmit the user's voice data to the server 308 and receive a command corresponding to a function to be performed in the electronic device 301 based on the voice data or text data converted based on the corresponding voice data. In example embodiments, the middleware 344 may dynamically delete some existing components or add new components. In embodiments, at least a portion of the middleware 344 may be included as part of the operating system 342 or may be implemented as software separate from the operating system 342.

The application 346 may, for example, include a home 451, a dialer 453, a SMS/MMS 455, an instant message (IM) 457, a browser 459, a camera 461, an alarm 463, a contacts 465, a voice recognition 467, an e-mail 469, a calendar 471, a media player 473, an album 475, a watch 477, a health 479 (e.g. measure exercise amount or blood sugar, etc.) or an environmental information 481 (e.g., barometric pressure, humidity, or temperature information) applications. In example embodiments, the application 346 may further include an information exchange application (not illustrated) that may support information exchange between the electronic device 301 and an external electronic device. The information exchange application may include, for example, a notification relay application for delivering designated information (e.g., a call, message, or alarm) to the external electronic device, or a device management application for managing the external electronic device. The notification relay application may, for example, transmit notification information corresponding to an event (e.g., email reception) generated in another application (e.g., the email application 469) of the electronic device 301 to the external electronic device, may receive notification information from the external electronic device, and may provide the notification information to the user of the electronic device 301.

The device management application may, for example, control the power (e.g., turn-on or turn-off) of the external electronic device or some component thereof (e.g., the display device 360 or the camera module 380) that communicate with the electronic device 301, or control the functions (e.g., brightness, resolution, or focus of the display device 360 or the camera module 380). The device management application may additionally or alternatively support installation, deletion, or update of applications running on the external electronic devices.

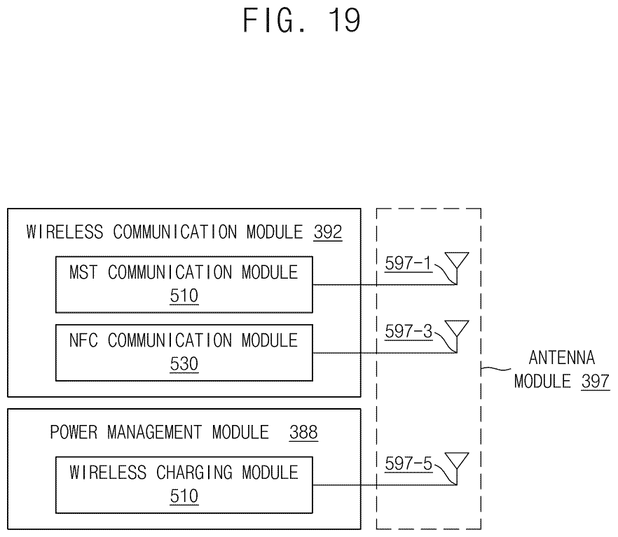

FIG. 19 is a block diagram illustrating an example of a wireless communication module, a power management module, and an antenna module included in an electronic device of FIG. 17.

Referring to FIG. 19, the wireless communication module 392 may include an MST communication module 510 and/or an NFC communication module 530, and the power management module 388 may include a wireless charging module 550. In this case, the antenna module 397 is connected to the MST antenna 597-1 connected to the MST communication module 510, the NFC antenna 597-3 connected to the NFC communication module 530, and the wireless charging module 550. A plurality of antennas including a wireless charging antenna 597-5 may be separately included. The descriptions repeated with or overlapping with descriptions of FIG. 14 will be omitted in the interest of brevity.

The MST communication module 510 may receive a signal including card information (e.g., credit card) control information or payment information from the processor 320, may generate a magnetic signal corresponding to the received signal, and may generate a magnetic signal corresponding to the received signal. The signal may be transmitted to the external electronic device 302 (e.g., POS device) through the MST antenna 597-1. In example embodiments, to generate a magnetic signal, the MST communication module 510 may include a switching module including one or more switches connected to the MST antenna 597-1, and the MST communication module 510 may control the switching module to change the direction of voltage or current supplied to 597-1 according to the received signal. The change in the direction of voltage or current may cause the direction of a magnetic signal (e.g., magnetic field) emitted from the MST antenna 597-1 to change accordingly. When detected by the external electronic device 302, the magnetic signal whose direction changes may cause a form and an effect similar to a magnetic field generated when the magnetic card corresponding to card information associated with a received signal is swiped by the card reader of the electronic device 302. In example embodiments, for example, payment-related information and control signals received in the form of magnetic signals by the electronic device 302 may be further transmitted to the server 308 (e.g., a payment server) via the second network 399.

The NFC communication module 530 may obtain a signal containing card information such as control information or payment information from the processor 320, and may transmit the obtained signal to the external electronic device 302 through the NFC antenna 597-3. In example embodiments, the NFC communication module 530 may receive a signal transmitted from the external electronic device 302 through the NFC antenna 597-3.

The wireless charging module 550 may include the connection setup circuit, the DC power combining circuit, and the PMIC included in the wireless power receiving device according to example embodiments described with reference to FIGS. 1 to 16. The wireless charging module 550 may wirelessly transmit power to the external electronic device 302 (e.g., a mobile phone or a wearable device) through the wireless charging antenna 597-5, or may wirelessly receive power from the external electronic device 302 (e.g., the wireless power transmission device 210 in FIG. 15). The wireless charging module 550 may, for example, support various wireless charging methods including a magnetic resonance method or a magnetic induction method.

Example embodiments may be applied to wireless power receiving device and any electronic devices and systems including the wireless power receiving device. For example, example embodiments may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, etc.

Example embodiments provide improved devices and methods to at least provide greater control of power levels output from a plurality of rectennas, and/or control the plurality of rectennas with greater efficiency, as compared to conventional devices and methods. For example, the improved devices and methods may control connections between the plurality of rectennas, based on an amount of power received by respective rectennas among the plurality of rectennas, to direct an output power of a target power level (or magnitude) to a battery. For example, the target power level may correspond to a charging standard required (or otherwise used) by the battery.

According to example embodiments, operations described herein as being performed by the wireless power receiving device 100, the plurality of rectennas 110, the connection setup circuit 120, the direct current (DC) power combining circuit 130, the power management integrated circuit (PMIC) 140, the connection setup circuit 120_1, the analyzing module 122, the grouping module 124, the control signal generating module 126, the DC power combining circuit 130a, the DC power combining circuit 130b, the PMIC 140b, the plurality of rectennas 110a, the plurality of rectennas 110_2, the plurality of rectifier circuits 114, the wireless power receiving device 100c, the connection setup circuit 120c, the DC power combining circuit 130c, the wireless power receiving device 100d, the connection setup circuit 120d, the DC power combining circuit 130d, the PMIC 140d, the wireless power receiving device 100x, the plurality of rectennas 110x, the connection setup circuit 120x, the DC power combining circuit 130x, the power management circuit 140x, the timer 160, the wireless power receiving device 100y, the plurality of rectennas 110y, the connection setup circuit 120y, the DC power combining circuit 130y, the PMIC 140y, the position sensor 170, the wireless power transmission and reception system 200, the wireless power transmission device 210, the wireless power receiving device 220, the electronic device 301, the network environment 300, the electronic device 302, the electronic device 304, the server 308, the processor 320, the input device 350, the sound output device 355, the audio module 370, the sensor module 376, the interface 377, the haptic module 379, the camera module 380, the power management module 388, the communication module 390, the subscriber identification module (SIM) 396, the antenna module 397, the main processor 321, the auxiliary processor 323, the connecting terminal 378, wireless communication module 392, the wired communication module 394, the MST communication module 510, the NFC communication module 530 and/or the wireless charging module 550 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 330). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

The foregoing is illustrative of example embodiments and is not to be construed as limiting thereof. Although example embodiments have been described, those skilled in the art will readily appreciate that many modifications are possible in the same without materially departing from the novel teachings and advantages of example embodiments. Accordingly, all such modifications are intended to be included within the scope of example embodiments as defined in the claims. Therefore, it is to be understood that the foregoing is illustrative of various example embodiments and is not to be construed as limited to the specific examples disclosed, and that modifications to the disclosed examples, as well as other examples, are intended to be included within the scope of the appended claims.

What is claimed is:

1. A wireless power receiving device comprising:
a plurality of rectennas configured to generate a plurality of sub-direct current (DC) powers based on a plurality of sub-alternating current (AC) powers received from an external source;
a DC power combining circuit;
processing circuitry configured to
divide the plurality of rectennas into one or more first groups, a plurality of second groups and a plurality of third groups based on power distribution information, a first reference value and a second reference value, the power distribution information being based on the plurality of sub-AC powers,
generate a control signal based on the one or more first groups, the plurality of second groups and the plurality of third groups including different numbers of rectennas,
control the DC power combining circuit to perform a series connection and a parallel connection for the plurality of sub-DC powers based on the control signal, the DC power combining circuit being configured to generate a combined DC power by performing a power synthesis based on the series connection and the parallel connection, and
generate an output power based on the combined DC power; and
a battery configured to store the output power.

2. The wireless power receiving device of claim 1, wherein
a first number of rectennas included in each of the one or more first groups is equal to each other;
a second number of rectennas included in each of the plurality of second groups is equal to each other;
a third number of rectennas included in each of the plurality of third groups is equal to each other; and
the first number of rectennas, the second number of rectennas, and the third number of rectennas are different from each other.

3. The wireless power receiving device of claim 2, wherein
the first number of rectennas is one;
the second number of rectennas is N, N being an integer greater than or equal to two; and
the third number of rectennas is M, M being an integer greater than or equal to three, and M being greater than N.

4. The wireless power receiving device of claim 3, wherein the processing circuitry is configured to:
obtain the power distribution information from the plurality of sub-AC powers;
set one rectenna having a magnitude of received sub-AC power greater than the first reference value as one of the one or more first groups based on the power distribution information;
set N rectennas each having a magnitude of received sub-AC power greater than the second reference value and less than or equal to the first reference value as one of the plurality of second groups based on the power distribution information;
set M rectennas each having a magnitude of received sub-AC power less than or equal to the second reference value as one of the plurality of third groups based on the power distribution information,
generate grouping information related to the one or more first groups, the plurality of second groups and the plurality of third groups; and
generate the control signal based on the grouping information.

5. The wireless power receiving device of claim 3, wherein the DC power combining circuit is configured to:
generate one of one or more first intermediate DC powers from the one rectenna included in one of the one or more first groups;
generate one of a plurality of second intermediate DC powers by connecting N sub-DC powers in series, the N sub-DC powers being generated by the N rectennas included in one of the plurality of second groups;
generate one of a plurality of third intermediate DC powers by connecting M sub-DC powers in series, the M sub-DC powers being generated by the M rectennas included in one of the plurality of third groups; and
output the combined DC power by connecting the one or more first intermediate DC powers, the plurality of second intermediate DC powers and the plurality of third intermediate DC powers in parallel.

6. The wireless power receiving device of claim 3, wherein
the combined DC power includes a first combined DC power and a second combined DC power; and
the DC power combining circuit is configured to
generate one of one or more first intermediate DC powers from the one rectenna included in one of the one or more first groups,
generate one of a plurality of second intermediate DC powers by connecting N sub-DC powers in series, the N sub-DC powers being generated by the N rectennas included in one of the plurality of second groups,
generate one of a plurality of third intermediate DC powers by connecting M sub-DC powers in series, the M sub-DC powers being generated by the M rectennas included in one of the plurality of third groups,
output the first combined DC power by connecting the one or more first intermediate DC powers and the plurality of second intermediate DC powers in parallel, and
output the second combined DC power by connecting the plurality of third intermediate DC powers in parallel.

7. The wireless power receiving device of claim 6, wherein
the battery includes a first sub-battery and a second sub-battery;
the output power includes a first output power and a second output power;
the processing circuitry is configured to
generate the first output power based on the first combined DC power, and
generate the second output power based on the second combined DC power;
the first sub-battery is configured to store the first output power; and
the second sub-battery is configured to store the second output power.

8. The wireless power receiving device of claim 1, wherein
the DC power combining circuit includes a plurality of switches; and
the processing circuitry is configured to control the DC power combining circuit by controlling the plurality of switches based on the control signal.

9. The wireless power receiving device of claim 1, wherein the plurality of rectennas comprises:
a plurality of antenna elements configured to receive the plurality of sub-AC powers; and
a plurality of rectifier circuits connected to the plurality of antenna elements, the plurality of rectifier circuits being configured to convert the plurality of sub-AC powers into the plurality of sub-DC powers.

10. The wireless power receiving device of claim 9, wherein each of the plurality of rectifier circuits includes:
a diode connected between a first node and a second node, the first node being an output terminal of one of the plurality of antenna elements;
a capacitor connected between the second node and a ground node; and
an inductor connected between the first node and the ground node.

11. The wireless power receiving device of claim 1, further comprising:
a timer configured to generate a first signal at regular time intervals,
wherein the processing circuitry is configured to obtain the power distribution information, divide the plurality of rectennas generate the control signal, control the DC power combining circuit to generate the combined DC power and generate the output power based on the first signal.

12. The wireless power receiving device of claim 1, further comprising:
a position sensor configured to generate a second signal based on detection of a change in position,
wherein the processing circuitry is configured to obtain the power distribution information, divide the plurality of rectennas, generate the control signal, control the DC power combining circuit to generate the combined DC power and generate the output power based on the second signal.

13. The wireless power receiving device of claim 1, wherein the processing circuitry is configured to:
divide the plurality of rectennas into the one or more first groups, the plurality of second groups, the plurality of third groups and a plurality of fourth groups based on the power distribution information, the first reference value, the second reference value and a third reference value; and
generate the control signal based on the one or more first groups, the plurality of second groups, the plurality of third groups and the plurality of fourth groups.

14. The wireless power receiving device of claim 1, wherein the battery is a Lithium (Li)-ion battery.

15. A method of operating a wireless power receiving device including a plurality of rectennas, processing circuitry, a direct current (DC) power combining circuit and a battery, the method comprising:
generating, by the plurality of rectennas, a plurality of sub-DC powers based on a plurality of sub-alternating current (AC) powers;
dividing, by the processing circuitry, the plurality of rectennas into a one or more first groups, a plurality of second groups and a plurality of third groups based on power distribution information, a first reference value and a second reference value, the power distribution information being based on the plurality of sub-AC powers;
generating, by the processing circuitry, a control signal based on the one or more first groups, the plurality of second groups and the plurality of third groups including different numbers of rectennas;
controlling, by the processing circuitry, a DC power combining circuit to generate a combined DC power by performing a series connection and a parallel connection for the plurality of sub-DC powers based on the control signal;
generating, by the processing circuitry, an output power based on the combined DC power; and
storing the output power in the battery.

16. The method of claim 15, wherein the dividing the plurality of rectennas includes:
setting one rectenna having a magnitude of received sub-AC power greater than the first reference value as one of the one or more first groups;
setting N rectennas each having a magnitude of received sub-AC power greater than the second reference value and less than or equal to the first reference value as one of the plurality of second groups, N being an integer greater than or equal to two; and
setting M rectennas each having a magnitude of received sub-AC power less than or equal to the second reference value as one of the plurality of third groups, M being an integer greater than or equal to three.

17. The method of claim 16, wherein the controlling causes the DC power combining circuit to generate the combined DC power including:
generating one of one or more first intermediate DC powers from the one rectenna included in one of the one or more first groups;
generating one of a plurality of second intermediate DC powers by connecting N sub-DC powers in series, the N sub-DC powers being generated by the N rectennas included in one of the plurality of second groups;
generating one of a plurality of third intermediate DC powers by connecting M sub-DC powers in series, the M sub-DC powers being generated by the M rectennas included in one of the plurality of third groups; and
outputting the combined DC power by connecting the one or more first intermediate DC powers, the plurality of second intermediate DC powers and the plurality of third intermediate DC powers in parallel.

18. The method of claim 16, wherein
the combined DC power includes a first combined DC power and a second combined DC power; and
wherein the controlling causes the DC power combining circuit to generate the combined DC power including:
generating one of one or more first intermediate DC powers from the one rectenna included in one of the one or more first groups;
generating one of a plurality of second intermediate DC powers by connecting N sub-DC powers in series, the N sub-DC powers being generated by the N rectennas included in one of the plurality of second groups;
generating one of a plurality of third intermediate DC powers by connecting M sub-DC powers in series, the M sub-DC powers being generated by the M rectennas included in one of the plurality of third groups;
outputting the first combined DC power by connecting the one or more first intermediate DC powers and the plurality of second intermediate DC powers in parallel; and
outputting the second combined DC power by connecting the plurality of third intermediate DC powers in parallel.

19. The method of claim 18, wherein
the output power includes a first output power and a second output power;
the battery includes a first sub-battery and a second sub-battery;
the generating the output power includes:
generating, by the processing circuitry, the first output power based on the first combined DC power, and
generating, by the processing circuitry, the second output power based on the second combined DC power; and
the storing the output power includes:
storing the first output power in the first sub-battery; and
storing the second output power in the second sub-battery.

20. A wireless power receiving device comprising:
a plurality of rectennas configured to generate a plurality of sub-direct current (DC) powers based on a plurality of sub-alternating current (AC) powers;
a DC power combining circuit;
processing circuitry configured to
divide the plurality of rectennas into a one or more first groups, a plurality of second groups and a plurality of third groups based on power distribution information, a first reference value and a second reference value, the power distribution information being based on the plurality of sub-AC powers,
generate a control signal based on the one or more first groups, the plurality of second groups, and the plurality of third groups,
control the DC power combining circuit to perform a series connection and a parallel connection for the plurality of sub-DC powers based on the control signal, the DC power combining circuit being configured to generate a combined DC power by performing a power synthesis based on the series connection and the parallel connection, and
generate an output power based on the combined DC power; and
a battery configured to store the output power,
wherein
a number of rectennas included in each of the one or more first groups is one,
a number of rectennas included in each of the plurality of second groups is N, N being an integer greater than or equal to two,
a number of rectennas included in each of the plurality of third groups is M, M being an integer greater than or equal to three, and M being greater than N,
the processing circuitry is configured to
obtain the power distribution information from the plurality of sub-AC powers,
set one rectenna having a magnitude of received sub-AC power greater than the first reference value as one of the one or more first groups based on the power distribution information,
set N rectennas each having a magnitude of received sub-AC power greater than the second reference value and less than or equal to the first reference value as one of the plurality of second groups,
set M rectennas each having a magnitude of received sub-AC power less than or equal to the second reference value as one of the plurality of third groups,
generate grouping information related to the one or more first groups, the plurality of second groups and the plurality of third groups, and
generate the control signal based on the grouping information, and
the DC power combining circuit is configured to
generate one of one or more first intermediate DC powers from the one rectenna included in one of the one or more first groups,
generate one of a plurality of second intermediate DC powers by connecting N sub-DC powers in series, the N sub-DC powers being generated by the N rectenna included in one of the plurality of second groups,
generate one of a plurality of third intermediate DC powers by connecting M sub-DC powers in series, the M sub-DC powers being generated by the M rectennas included in one of the plurality of third groups, and
output the combined DC power by connecting the one or more first intermediate DC powers, the plurality of second intermediate DC powers and the plurality of third intermediate DC powers in parallel.
